(19) United States
(12) Patent Application Publication
(10) Pub. No.: US 2024/0368034 A1
(43) Pub. Date: Nov. 7, 2024

(54) A CEMENTITIOUS MATERIAL BINDER AND METHODS AND SYSTEMS FOR PRODUCING THE SAME WHICH DO NOT RELY ON A SURFACE-ALONE REACTION

(71) Applicant: YUMMET LLC, Tucson, AZ (US)

(72) Inventors: Brittany ZIMMERMAN, Tucson, AZ (US); Christopher COGSWELL, Tucson, NH (US); Kevin A. MACDONALD, Tucson, AZ (US)

(21) Appl. No.: 18/714,759

(22) PCT Filed: Nov. 30, 2022
(86) PCT No.: PCT/US2022/051456

§ 371 Date: May 30, 2024

Related U.S. Application Data
(60) Provisional application No. 63/284,399, filed on Nov. 30, 2021.

(51) Int. Cl. C04B 12/00; B01J 19/06; B01J 19/24; C04B 40/02

(52) U.S. Cl. CPC C04B 12/005; B01J 19/06; B01J 19/245; C04B 40/0231

(57) ABSTRACT

Methods and systems for producing cement binder without wall packing or interfacial transition zones are provided. A metal hydroxide is reacted with a silicate to produce a silicate precursor. The silicate precursor is then mixed with aluminosilicate material which forms a condensation reaction directly in the solution, resulting in a binder that does not rely on a surface-alone reaction.

This application claims priority to U.S. Provisional Application No. 63/284,399 filed on Nov. 30, 2021, the contents of which are hereby incorporated by reference in their entirety.

Innovation in infrastructure is one of the foremost goals of the UN Sustainable Development Goals. These goals aim to improve the sustainability of human development for future generations by limiting emissions, building resilient structures, and finding new sources of renewable feedstock materials. However, the most commonly utilized construction material, cementitious concrete, is highly carbon emissive. This is due to the use of calcium oxide which is a necessary component in the production of cement. Calcium oxide is often converted from mined limestones, which are composed of Calcium Carbonates (CaCO₃). Upon heating at high temperatures (a process known as calcination) the calcium carbonate decomposes to calcium oxide and carbon dioxide gas, which is often emitted as a pollutant into the environment. This process means that for every ton of cement produced, 0.9 tons of CO₂ gas are emitted. The concrete industry in total produces approximately 3 billion tons of CO₂ annually, making it responsible for 6-10% of worldwide carbon emissions.

Although the issue of carbon emissions from concrete is well documented, to date there are limited solutions to this challenge. Attempts to solve this problem are generally placed into two broad categories of emission reduction. The first strategy involves capture and storage of the CO₂ emitted in the calcination process. This method usually relies on adsorbent materials at the exhaust of calcination systems, and although effective at stopping emission of gaseous CO₂, it still leaves open the question of long-term storage of this captured pollutant. In the second strategy, attempts are made to utilize CO₂ in some way in the production of cement or concrete. These include attempts to incorporate CO₂ into cementitious materials through bubbling of gaseous streams into the concrete during curing, the use of liquified CO₂ as the solvent for cement production, or the use of mineralized CO₂ as an aggregate species in the cement production step. However, these methods do not solve the root issue, which is the use of calcium oxide as the activator species in cement (and therefore concrete) production.

Other species of cementitious/solid polymer species have also been investigated for use as a cement binder. However, these materials often rely on the use of specific clay species such as metakaolin MK-750 which still requires high temperature calcination for use. Still other systems involve the use of non-hydraulic systems such as Sorrel Cement, alkali activated slags, glasses and fly ashes, slag cement and volcanic ashes.

Alkali activated materials require the use of high pH (15 or higher) materials, or other Na salts that are synthesized from other processes. These materials rely on the dissolution of silicates and reactions to form silicate polymers (geopolymers).

Another challenge in the production of traditional cement binders is the interfacial transition zone which arises as a consequence of the hydration reactions at the surface. In fresh concrete a density gradient develops around the aggregate particles during hydration, resulting in a different microstructure of the hydrated cement paste immediately adjacent to the aggregates. This zone around the aggregate is called the interfacial transition zone (ITZ). This zone may be consequently described as a heterogeneous area with a porosity gradient and a complementary gradient of anhydrous and hydrated phases. A surface reaction creates a diffusion-controlled reaction, where materials need to diffuse through layer built up on surfaces during hydration. The rate of reaction is thereby reduced, as reagents need to diffuse towards one another through a surface layer. By contrast the present invention results from a condensation reaction in the solution, with diffusion occurring in the solution at a rate several decades larger than that through the solid hydration products. As a result, the ITZ does not occur, and the bond between binder and aggregate is enhanced. The density becomes more homogeneous and no ITZ short percolation will occur. The ITZ of traditional cement binders and resulting microstructure of cementitious material produced therefrom is generally negatively impacted by the inability of sufficient reaction products to overcome the wall effect, thereby resulting in diminished structural properties over the ITZ free materials.

The process described according to the present disclosure allows production of a cementitious material without the need for calcination, significantly limiting carbon dioxide emissions from the production of traditional cement binders. The binder produced according to the present disclosure allows for the incorporation of a more significant portion of brines and carbonaceous materials than other cementitious binders without the loss of textural and physical properties. Because of this, it is possible to produce a binder according to the present disclosure in a novel way as compared to other cementitious materials. According to certain embodiments disclosed herein, this process is coined the Yummet™ Process, whereby saltwater is converted into sodium hydroxide, alkali metal brines, and potable water. The sodium hydroxide and brine from the water purification process are then used as feedstocks for the cementitious material binder, allowing this process to produce significant amounts of potable water without any brine. Secondary addition of carbonaceous compounds, such as biochar or other mineralized carbon dioxide species, are also possible to further improve the carbon dioxide balance of certain embodiments of the presently disclosed cementitious binder. According to the presently disclosed process, cementitious binder can be produced from seawater and an aluminosilicate source. The flexibility of the material composition allows incorporation of feedstocks traditionally considered waste products of water desalination, cement production, and other industries. The resulting microstructure of the cementitious material according to the present disclosure shows a significantly decreased inter-transition zone, at times showing none, meaning the material exhibits good structural properties even with higher contents of carbon or alkali salts than those of traditional cement binders.

### SUMMARY

The present disclosure relates to a cementitious material binder and methods and systems for producing said binder. Importantly and more specifically, the present disclosure relates to the production of a cementitious material binder without the need for calcination, which significantly limits carbon dioxide emissions from the production of said cementitious material.

According to some embodiments, the process includes reacting a metal hydroxide with a silicate material to produce a silicate precursor. The silicate precursor is then reacted with an aluminosilicate material to produce a cementitious material binder. Upon mixing with a second suspension of aluminosilicate material, the reactive silicate precursors react with these additional materials in a condensation reaction directly in the solution, resulting in a binder that does not rely on a surface-alone reaction as is the case with the pozzolanic reaction. This condensation reaction thereby develops a cementitious material that does not have a wall packing, or interfacial transition zone effect. As such, the binder so produced differs from that of most geopolymers, hydraulic cements or other mineral based binders such as calcinated lime, Portland cement, conventional alkali activated cement and slag cement.

Additionally, the binder produced according to some embodiments of the present disclosure allows for the incorporation of a more significant portion of brines and carbonaceous materials as compared to other cementitious binders and without the associated loss of textural and physical properties.

According to some embodiments disclosed herein, saltwater is converted into sodium hydroxide, alkali metal brines, and potable water. The sodium hydroxide and brine from the water purification process are then used as feedstocks for the cementitious material binder, allowing this process to produce significant amounts of potable water without any brine. In other embodiments, secondary addition of carbonaceous compounds, such as biochar or other mineralized carbon dioxide species, are also possible to further improve the carbon dioxide balance of the presently disclosed process.

According to the presently disclosed process, cementitious binder can be produced from seawater and an aluminosilicate source. The flexibility of the material composition allows incorporation of feedstocks traditionally considered waste products of water desalination, cement production, and other industries. The resulting microstructure of the cementitious material according to the present disclosure shows a significantly decreased inter-transition zone, at times showing none, meaning the material exhibits good structural properties even with higher contents of carbon or alkali salts or alkaline earth metals than those of traditional cement binders.

The present disclosure also relates to a cementitious material binder material that shows increased strength and paste density, by reducing the interfacial transition zone effect. One consequence of this microstructure is that there is no percolation of the ITZ possible. This is exhibited by the very high early age strength and the resistance to pressure and concentration gradient induced flux in the concrete. In other embodiments, the present disclosure relates to a cementitious material binder material made according to the process disclosed herein. In still further embodiments, the cementitious material binder made according to the process disclosed herein does not have a wall packing, or interfacial transition zone effect.

As used herein, aluminosilicates are minerals composed of aluminium, silicon, and oxygen, plus countercations. Naturally occurring microporous, hydrous aluminosilicate minerals are referred to as zeolites. A wide variety of aluminosilicate materials are contemplated under the disclosure. The disclosure is not meant to be limited by any one type of aluminosilicate used.

As used herein, metal hydroxides are hydroxides of metals. They are often strong bases. They consist of hydroxide anions and metallic cations. Some metal hydroxides, such as alkali metal hydroxides, ionize completely when dissolved. Certain metal hydroxides are weak electrolytes and dissolve only partially in aqueous solution. Certain non-limiting examples of metal hydroxides includes: Aluminium hydroxide, Beryllium hydroxide, Cobalt (II) hydroxide, Copper (II) hydroxide, Curium hydroxide, Gold (III) hydroxide, Iron (II) hydroxide, Mercury (II) hydroxide, Nickel (II) hydroxide, Tin (II) hydroxide, Uranyl hydroxide, Zinc hydroxide, Zirconium (IV) hydroxide, Lithium hydroxide, Rubidium hydroxide, Cesium hydroxide, Sodium hydroxide, and Potassium hydroxide. Alkali hydroxides are a class of chemical compounds which are composed of an alkali metal cation and the hydroxide anion (OH—). The alkali hydroxides are: Lithium hydroxide (LiOH), Sodium hydroxide (NaOH), Potassium hydroxide (KOH), Rubidium hydroxide (RbOH), and Caesium hydroxide (CsOH). Other metal hydroxides include Gallium (III) hydroxide, Lead (II) hydroxide, Thallium (I) hydroxide, Thallium (III) hydroxide. A wide variety of metal hydroxides are contemplated under the disclosure. The disclosure is not meant to be limited by any one type of aluminosilicate used.

As used herein, ceramic material is an inorganic, non-metallic oxide, nitride, or carbide material. Some elements, such as carbon or silicon, may be considered ceramics. Ceramic materials are generally brittle, hard, strong in compression, and weak in shearing and tension. They typically withstand chemical erosion that occurs in other materials subjected to acidic or caustic environments. Ceramics generally can withstand very high temperatures, ranging from 1,000° C. to 1,600° C. (1,800° F. to 3,000° F.). A wide variety of ceramics are contemplated under the disclosure. The disclosure is not meant to be limited by any one type of ceramic used.

### BRIEF DESCRIPTION OF THE DRAWINGS

FIG. 1. A general reaction for producing concrete material. A metal hydroxide is reacted with silica to produce a precursor activated silica species (“silicate precursor”). The silicate precursor is reacted with an aggregate species (“aluminosilicate material”) in water to produce concrete precursor material (“cementitious material binder”).

FIG. 2. A system and process for producing the cementitious material binder. Seawater, municipal wastewater, and CO₂ can serve as feedstock for Process C. Potable water, oxygen, and green hydrogen can be output from Process C as well as a Brine solution which can be optionally fed into Process B or Process D. Biomass and CO₂ can serve as feedstock for Process B for Biomass Processing. Biochar can be output from Process B and optionally fed into Process D. Process D can accept brine solution from Process C and optionally biochar from process B as well as other optional feedstocks such as recycled steel slag, recycled glass, and recycled concrete and other ceramics for cementitious material binder and concrete production. Cementitious binder and green concrete can be output from Process D.

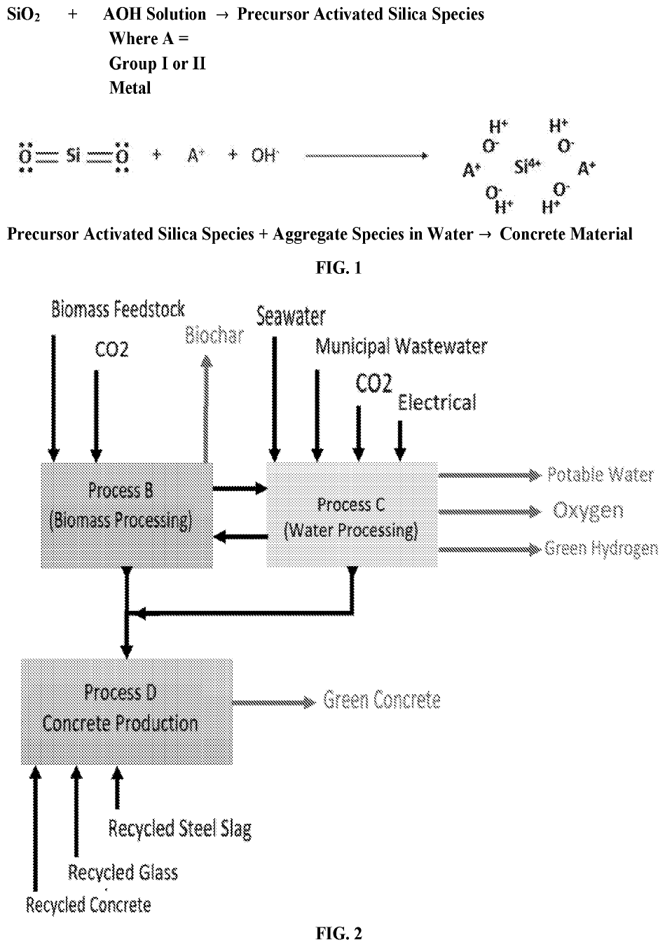

### DETAILED DESCRIPTION OF EMBODIMENTS

As described herein, systems and methods for producing cement binder significant reduction of the volume of interfacial transition zones are provided. The systems and methods include reacting a metal hydroxide with a silicate material to produce a silicate precursor and then reacting the silicate precursor with an aluminosilicate material to form a binder which does not rely on a surface-alone reaction.

According to certain embodiments, the binder manufacture is a two-step process, whereby a metal hydroxide, in this example sodium hydroxide, is reacted with silica to form a sodium silicate precursor. According to some embodiments, to produce this precursor, siliceous material is dissolved in a solution of alkali or alkaline hydroxide in water with a pH between 12 and 16 until the point that the resulting solution is a colloidal suspension of reactive silica species and alkali/alkaline earth species. In some non-limiting embodiments, the pH of the solution is in a range of approximately 12-16, 13-13, 14-16, or 15-16. In other non-limiting embodiments, the pH of the solution is at or above approximately 12. For example, the reaction may proceed as follows:
AOH→(A)⁺+(OH)⁻ where A=any alkali or alkaline earth element
SiO₂→(SiO)^{±}
(SiO)^{±}+OH⁻→(SiₓO_{y}A_{z})ₙ+H₂O where x, y, z are integers and n is the number of polymerized units. This material is the precursor.

Upon addition of a secondary ceramic species, such as, according to some embodiments, aluminate, silicate, nitride, carbonate, sulphate, or other non-limiting ceramic precursors, in aqueous solution, a precursor solution further reacts to form a network of solid material. It is believed that this occurs through surface activation of oxide species which become incorporated into the ceramic matrix of the aluminosilicate material.

According to some embodiments, curing happens at room temp and atmospheric pressure (STP), although other conditions are contemplated.

In this reaction the byproducts produced in the creation of the precursor include unreacted metal hydroxides, unreacted aluminosilicate feedstocks, and water due to the condensation reaction which forms the aluminosilicate solid structure.

According to some embodiments, the precursor, with a sodium modulus between one and three, is then added to a suspension of amorphous aluminosilicate material such as soda glass, e glass or other amorphous silicate materials, metal slag, fly ash, volcanic ash, metaclays, or other naturally occurring or synthetic silica or alumina-based glasses. For example, one reaction may proceed as follows:

The precursor is added to water and aluminosilicate materials.

The precursor material in the solution reacts with the alumino-silicate materials which are being dissolved to create a reaction in the solution. The resulting mineral is developed as a precipitate in the solution.

The mixture would be proportioned so as to maximize the degree of reaction, with the silicate or aluminosilicate typically in excess. For example, according to some embodiments, Silica Modulus can be 3:1, and Activator:Silicate ratio can be 0.5.

According to certain embodiments, the precursor solution can be produced at scale in an atmospheric environment with mixing. The silicon dioxide is added to the metal hydroxide in stages with good mixing to ensure full incorporation of the silicon dioxide. According to some embodiments, the resulting solution is a black viscous suspension, although the addition of silica moduli by using differing contents of silicon/metal hydroxide is possible to provide alternative engineering properties. According to some embodiments, a silica modulus of 3:1 to 1.5:1 has been used. According to other non-limiting embodiments, an inorganic material can be mixed in to the resulting solution or at precursor stages in order to produce final materials with differing properties.

Once created, the precursor material can be used as is or dried for shipping to a secondary location of interest. Once dried the addition of secondary water to the system is necessary to activate the precursor for further use. After the precursor is well mixed and all silica is incorporated, ground secondary ceramic species can be added to the solution with mixing. After mixing, the solution can then be set and allowed to cure for a time dependent on the temperature. For example, according to some embodiments, 4-5 hours curing at room temperature will result in a final solid structure. Other non-limiting embodiments enable setting times as short as 15 minutes and as long as several days (>72 hours). It is envisioned that according to some embodiments setting times can range from approximately 15 minutes to less than approximately 1, 2, 3, 4, 5, 6, 7, 8, 9, 10, 11, 12, 24, 48, or 72 hours. A concrete structure according to the present disclosure can therefore be cast on site for use or precast and shipped as necessitated by the application of interest.

Upon mixing with the second suspension of aluminosilicate material, the reactive silicate precursors react with these additional materials in a condensation reaction directly in the solution, resulting in a binder that does not rely on a surface-alone reaction as is the case with the pozzolanic reaction, as defined in the American Concrete Institute document 232R, or 233R. This condensation reaction thereby develops a cementitious material that will not have a wall packing, or interfacial transition zone effect. As such, the binder so produced differs from that of most geopolymers, hydraulic cements or other mineral based binders such as calcinated lime, Portland cement, conventional alkali activated cement and slag cement.

In some embodiments, the presently disclosed material differs from others in a few important ways. First, it does not require calcination at any stage in the production process, and does not utilize calcium oxide as an activator species. Because of this, the direct emissions of carbon dioxide from calcination does not occur in the production of our material. Second, our material can utilize any silicon dioxide precursor structure which can dissolve in a highly basic metal hydroxide solution. Other important distinctions of the presently disclosed material include:
The material does not display interface transition zones;
The material does not rely on surface-only reactions;
The material displays properties of high compressive (according to some embodiments 5000 psi at 1 day), and flexural strength at early ages (according to some embodiments 500 psi at 1 day), low shrinkage, high modulus of elasticity and high resistance to chloride ion penetration (ASTM C1567 7×10⁻¹² m²/sec) without admixtures;
The material can be used to produce high strength, high performance concrete without the use of accelerators or external sources of heat. This material can be used for rapid pavement repairs, modular construction and precast concrete without the emissions normally associated with the heat or steam curing typically applied in conventional methods.
The material can be cured at room temperatures. This material does not require secondary activator species or structural directing agents. Additionally, it does not require specific clay/zeolitic precursors such as other geopolymers.

1. A method for producing a cementitious material binder which does not rely on a surface-alone reaction, comprising the steps of:
converting brine into a potable water and at least one of an alkali metal hydroxide and an alkali metal brine;
reacting at least one of the alkali metal hydroxide and the alkali metal brine with a silicate material to produce a silicate precursor;
reacting in a surface reaction and a condensation reaction the silicate precursor with an aluminosilicate material to produce a cementitious material binder having substantially diminished interfacial transition zones;
wherein the method does not rely on a surface-alone reaction;
wherein the method does not use calcium oxide as an activator; and
wherein the method is implemented without calcination.

2. The method according to claim 1 further comprising the step of:
adding at least one carbonaceous compound or mineralized carbon dioxide species.

3. The method according to claim 1, wherein:
the silicate precursor is made by dissolving the silicate material in a basic solution of the alkali metal hydroxide and water to produce the silicate precursor;
the silicate precursor comprising a colloidal suspension of reactive silica species and at least one of an alkali metal or an alkaline earth metal.

4. The method according to claim 1, wherein the silicate precursor is produced according to the following reaction:
AOH→(A)⁺+(OH)⁻.
SiO₂→(SiO)^{±}
(SiO)^{±}+OH⁻→(SiₓO_{y}A_{z})ₙ+H₂O
wherein A=any alkali or alkaline earth element; and wherein
x, y, and z are integers and n is the number of polymerized units.

5. The method according to claim 1, wherein:
the silicate precursor comprises an alkali modulus of between approximately 1-3.

6. The method according to claim 1, wherein:
the step of reacting the silicate precursor with the aluminosilicate material further comprises reacting a secondary ceramic species to form a network of solid material.

7. (canceled)

8. The method according to claim 1, further comprising:
curing the cementitious material binder at room temperature and atmospheric pressure.

9. The method according to claim 1, further comprising:
reacting the silicate precursor with a suspension of amorphous aluminosilicate material.

10. (canceled)

11. The method according to claim 1, wherein:
the silicate precursor is added to water and aluminosilicate material to precipitate a mineral.

12. The method according to claim 1, wherein:
silicon dioxide is mixed into the alkali metal hydroxide in stages.

13. The method according to claim 1, wherein:
the silicate precursor is a black viscous suspension.

14. (canceled)

15. (canceled)

16. (canceled)

17. A cementitious material binder made according to the method of claim 1, comprising:
a substantially diminished interfacial transition zone.

18. A system for producing the cementitious material binder made according to claim 1, comprising:
a cementitious material binder facility having a first reactor and a second reactor;
the first reactor configured to react alkali metal hydroxide with silicate material to produce silicate precursor; and
the second reactor configured to react silicate precursor with aluminosilicate material to produce cementitious material binder.

19. The system for producing the cementitious material binder made according to claim 18, further comprising:
a water processing facility having a water reactor, the water reactor configured to convert seawater into potable water and brine solution; and
the first reactor of the cementitious material binder facility configured to react alkali metal hydroxide in the brine solution with silicate material to produce silicate precursor.

20. The system for producing the cementitious material binder according to claim 18, the system further comprising:
a biomass processing facility having a biomass reactor, the biomass reactor configured to convert biomass feedstock into a carbonaceous compound;
the first reactor of the cementitious material binder facility configured to react the carbonaceous compound with alkali metal hydroxide and silicate material to produce silicate precursor; or alternatively,
the second reactor of the cementitious material binder facility configured to react the carbonaceous compound with silicate precursor and aluminosilicate material to produce cementitious material binder.
